(19) United States
(12) Patent Application Publication
(10) Pub. No.: US 2013/0077317 A1
(43) Pub. Date: Mar. 28, 2013

(54) LIGHT-GUIDING MEMBER AND LIGHT BULB HAVING THE SAME

(71) Applicant: SHIH-FENG PENG, HSINCHU CITY (TW)

(72) Inventor: SHIH-FENG PENG, HSINCHU CITY (TW)

(73) Assignee: SUMITRONICS TAIWAN CO., LTD., HSINCHU CITY 300 (TW)

(21) Appl. No.: 13/240,052

(22) Filed: Sep. 22, 2011

(51) Int. Cl. F21V 29/00; G02B 6/00

(52) U.S. Cl. 362/294; 362/317

(57) ABSTRACT

The instant disclosure relates to a light bulb, which includes a connecting cap, a heat-dissipating seat, a LED module, a light-guiding member, and a bulb. The heat-dissipating seat is disposed on one end of the connecting cap, and the LED module is disposed on the heat-dissipating seat. The light-guiding member is connected to the heat-dissipating seat and covers the LED module. At least one microstructure is formed on the surface of the light-guiding member for changing the light projection path. The bulb is arranged over the light-guiding member. Thereby, the light bulb can illuminate a wider area and achieve more uniform brightness. A light-guiding member is also disclosed.

### BACKGROUND OF THE INVENTION

Field of the Invention

The instant disclosure relates to a light-guiding member and a light bulb having the same; more particularly, to a light-guiding member and light bulb having the same, where the light-emitting diode (LED) is used as the light source.

Description of Related Art

LEDs have many advantages such as being more energy efficient, have longer service life, and being brighter, among others. Because of these attributes, LEDs have been adopted progressively for widespread use with lighting devices, such as LED light bulbs.

Nevertheless, LED light source, such as LED dies, is rather uni-directional and can only project light through a specific light output surface (usually the top surface of a die), thus lighting up only a limited amount of space. This behavior may significantly reduce the brightness, particularly in the lateral direction such as near the conducting cap portion of the light bulb. To address the issue, one of the existing techniques involves using a light-guiding structure to assist with re-distributing the light projections. However, such technique may result in uneven light distribution and cause visual issues for users. Tremendous efforts have been inputted by industrial manufacturers to develop a light bulb capable of providing a wider light projection and uniform brightness.

To address the above issues, the inventor strives via industrial experience and academic research to present the instant disclosure, which can effectively improve the limitations described above.

### SUMMARY OF THE INVENTION

The instant disclosure provides a light-guiding member and a light bulb having the same. The light bulb can achieve a wider light projection and uniform brightness.

The light bulb comprises a connecting cap, a heat-dissipating seat, a LED module, a light-guiding member, and a bulb. The heat-dissipating seat is arranged on one end of the connecting cap, and the LED module is disposed on the heat-dissipating seat. The light-guiding member is connected to the heat-dissipating seat and covers the LED module. At least one microstructure is formed on the surface of the light-guiding member to change the light projection path. The bulb is disposed over the light-guiding member.

The instant disclosure also provides a light-guiding member used with a LED module. The distinctive feature of the light-guiding member is the inclusion of at least one microstructure formed on the surface thereof for changing the light projection path. The light-guiding member has a rounded base portion, which is arranged above the LED module.

Through the microstructure of the light bulb of the instant disclosure, the light projection path of the LED module can be adjusted to provide wider light projection and uniform brightness.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a schematic view of a light bulb for a first embodiment of the instant disclosure.

FIG. 2 is an exploded view of the light bulb for the first embodiment of the instant disclosure.

FIG. 3A is a schematic view of a light-guiding member having a plurality of microstructures for the first embodiment of the instant disclosure.

FIG. 3B is a schematic view of a plain light-guiding member without microstructures for the first embodiment of the instant disclosure.

FIG. 4 is a sectional view of the light-guiding member for a second embodiment of the instant disclosure.

FIG. 5 is a sectional view of the light-guiding member for a third embodiment of the instant disclosure.

### DETAILED DESCRIPTION OF PREFERRED EMBODIMENTS

[First Embodiment]

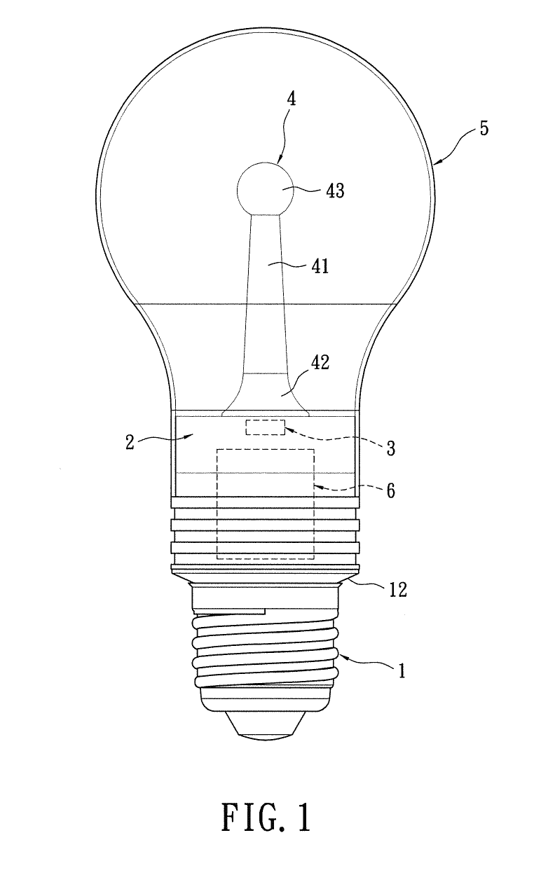

Please refer to FIG. 1, which shows a light bulb of the instant disclosure. The light bulb comprises a connecting cap 1, a heat-dissipating seat 2, a LED module 3, a light-guiding member 4, a bulb 5, and a power-supply module 6.

The connecting cap 1 is arranged on one end (bottom end) of the heat-dissipating seat 2, and the light-guiding member 4 is connected to the other end (top end) thereof. In the instant exemplary embodiment, an E27 style threaded cap is used. The LED module 3 is disposed on the heat-dissipating seat 2 and covered by the light-guiding member 4. The bulb 5 is arranged over the light-guiding member 4, and the power-supply module 6 is received within the light bulb.

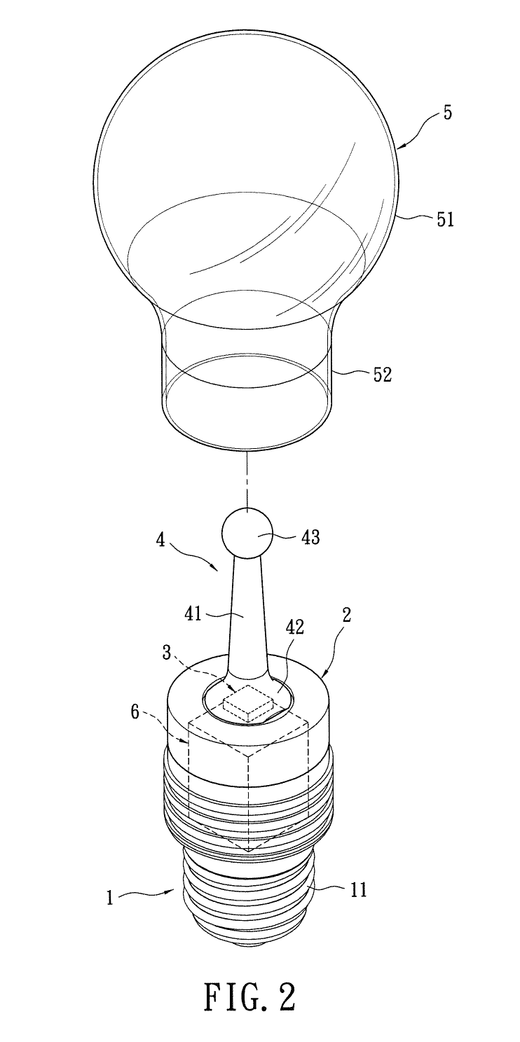

Please refer to FIG. 2, which shows the connecting cap 1 having a mounting portion 11 and an assembling portion 12. The outer appearance and function of the connecting cap 1 are not the main focus of the instant disclosure, therefore no further elaboration is given hereinafter. Being arranged inside of the connecting cap 1, the power-supply module 6 is connected electrically to the LED module 3 and the interior surface of the mounting portion 11, to establish electrical connection with the external power source, e.g., power outlet.

The heat-dissipating seat 2 is arranged on the assembling portion 12 of the connecting cap 1. The heat-dissipating seat 2 is made from thermally conductive material such as aluminum metal, alumina, aluminum nitride, or plastic. However, the material choice is not restricted. Structurally, the heat-dissipating seat 2 can have a hollow or solid body. For the instant embodiment, the heat-dissipating member 2 has an aluminum hollow body, to enhance the heat dissipation efficiency of the light bulb. Moreover, based on applications, a nano-coating can be applied to the exterior surface of the heat-dissipating seat 2 in forming a thermal radiation layer thereon (not labeled). Thereby, heat can be dissipated by means of thermal radiation to the ambient to increase the heat dissipation rate.

The LED module 3 includes at least one LED. When multiple LEDs are available, the LEDs can be grouped in a particular array. Likewise, based on applications, the LED module 3 can be produced in a variety of types. For example, the LED module 3 can include surface mount LED or cylindrical packaged LED.

The light-guiding member 4 is arranged on the heat-dissipating seat 2. In particular, the light-guiding member 4 has a light-guiding portion 41, a rounded base portion 42, and a top portion 43. The base portion 42 is arranged adjacently to one end of the heat-dissipating seat 2, whereas the top portion 43 is arranged away from the heat-dissipating seat 2. The light-guiding member 4 can be sized according to the type of the LED module 3.

The base portion 42 is arched and arranged over the LED module 3. Without restriction, the base portion 42 can be arched in such a way to work cooperatively with the LED module 3, to achieve a wider light projection angle or desired projection angle of the user. The top portion 43 can be produced in a variety of shapes based on needs without restriction, such as being circular, rectangular, or rhombus-like shaped, among others.

The bulb 5 has a main body 51 and a narrowed mating portion 52 extending therefrom. The main body 51 is spherically shaped and hollowed; however, the main body 51 is not restricted structurally. The mating portion 52 of the bulb 5 is mounted to the assembling portion 12 of the connecting cap 1. The bulb 5 can be a glass bulb that is transparent or frosted in allowing light to project therethrough. Thereby, light emitted by the LED module 3 can be directed by the light-guiding member 4 and pass through the bulb 5 to project outwardly.

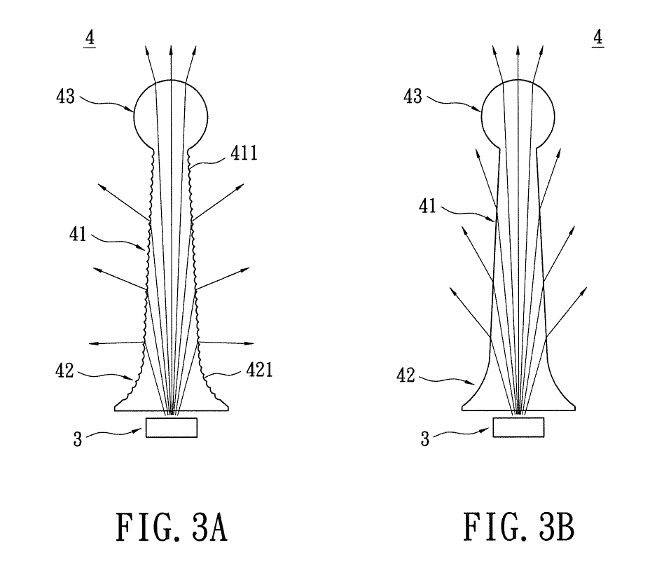

Please refer to FIG. 3A, which shows the light-guiding member 4. At least one microstructure 411 is formed on the light-guiding portion 41 and at least one microstructure 421 is formed on the base 42, where the microstructures 411 and 421 serve to change the light projection path. However, when in use, at least one microstructure (not shown) can also be formed on the top potion 43, but is not restricted thereto. To obtain the microstructures, a mold can first be made to take the shape of the microstructures, and followed by using injection molding or roll forming technique to produce the light-guiding member 4 with preferred microstructures thereon. However, the manufacturing method of the light-guiding member 4 is not restricted.

For the instant embodiment, as shown in FIG. 3A, multiple microstructures 411 and 421 are formed on the light-guiding portion 41 and the base portion 42, respectively. Each of the microstructures 411 and 421 are formed concavedly on the surface of the light-guiding member 4 and arranged in a continuous fashion. The purpose of the microstructures 411 and 421 is to change the light projection angle and direction for better lighting effect. The actual shape of each of the microstructures 411 and 421 is not restricted, which may be hemispherical, semi-elliptical, or having multiple continuously connected surfaces. Please compare to FIG. 3B, which shows the light paths projecting from the light-guiding member 4 without any microstructure formed thereon. As shown in FIG. 3A, the presence of the microstructures 411 and 421 alter the projecting directions of the light emitted from the LED module 3. The alteration enables the light bulb to illuminate a wider area by increasing the brightness in the rearward and lateral directions. Moreover, the microstructures 411 and 421 can diffuse the light in allowing the light to project uniformly from the bulb 5.

[Second Embodiment]

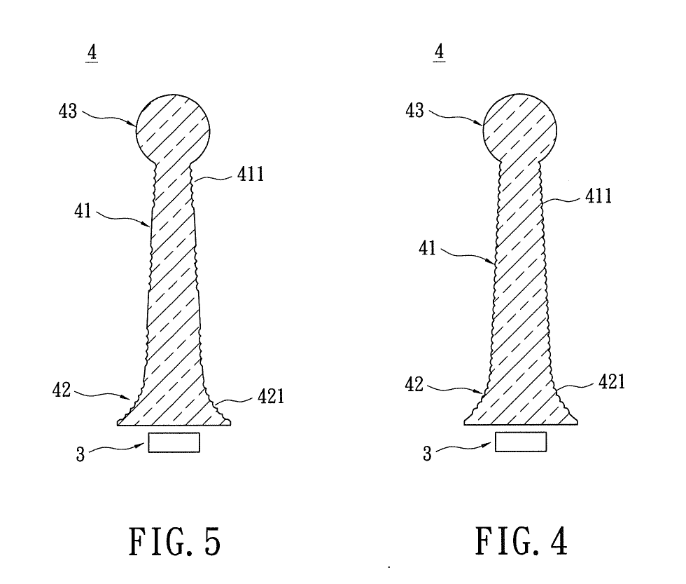

Please refer to FIG. 4, which shows the light-guiding member 4 for a second embodiment of the instant disclosure. The same numerals have been used in FIG. 4 to indicate identical components between the embodiments. The second embodiment differs from the previous embodiment by: each of the microstructures 411 and 421 are formed protrudingly on the surface of the light-guiding member 4. Thereby, the light bulb of the instant disclosure can be equipped with the light-guiding member 4 having protruding microstructures formed thereon.

[Third Embodiment]

Please refer to FIG. 5, which shows the light-guiding member 4 for a third embodiment of the instant disclosure. The same numerals have been used in FIG. 5 to indicate identical components between the embodiments. The third embodiment differs from the first embodiment by: the microstructures 411 and 421 are arranged in isolated groups on the surface of the light-guiding member 4. The distance between each group of microstructures can be adjusted according to needs without restrictions. Thus, the microstructures 411 and 421 can be arranged arbitrarily on the light-guiding member 4.

Based on the above, the light bulb of the instant disclosure utilizes the microstructures 411 and 421 to adjust the projection paths of light emitted from the LED module 3. Thereby, the light bulb can illuminate a wider area, such as by improving brightness in the lateral direction in providing more uniform brightness.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A light bulb, comprising:
a connecting cap;
a heat-dissipating seat disposed on one end of the connecting cap;
a LED module disposed on the heat-dissipating seat;
a light-guiding member arranged on the heat-dissipating seat to receive light output from the LED module, wherein at least one microstructure is formed on the light-guiding member to modify the light projection path of the LED module; and
a bulb covering the light-guiding member

2. The light bulb of claim 1, wherein the light-guiding member has a base portion formed on one end thereof for covering the LED module.

3. The light bulb of claim 1, wherein the microstructure is formed concavedly or protrudingly on the light-guiding member.

4. The light bulb of claim 3, wherein for multiple microstructures, the microstructures are arranged continuously or in isolated groups on the light-guiding member.

5. The light bulb of claim 1, wherein the bulb is transparent.

6. The light bulb of claim 5, wherein the bulb has a main body and a mating portion extending therefrom, wherein the connecting cap has an assembling portion, and wherein the mating portion of the bulb is mounted on the assembling portion of the connecting cap.

7. The light bulb of claim 1, further comprising a power supply module disposed within the connecting cap and connected electrically to the LED module and the connecting cap.

8. A light-guiding member for a LED module, comprising:
a base portion correspondingly arranged above the LED module for receiving a light output thereof; and
at least one microstructure for modifying the light projection path of the output of the LED module.

9. The light-guiding member of claim 8, wherein the microstructure is formed concavedly or protrudingly thereon.

10. The light-guiding member of claim 9, wherein for multiple microstructures, the microstructures are arranged continuously or in isolated groups thereon.
